(19) United States
(12) Patent Application Publication
(10) Pub. No.: US 2021/0232847 A1
(43) Pub. Date: Jul. 29, 2021

(54) METHOD AND APPARATUS FOR RECOGNIZING TEXT SEQUENCE, AND STORAGE MEDIUM

(71) Applicant: SHENZHEN SENSETIME TECHNOLOGY CO., LTD., Shenzhen (CN)

(72) Inventors: Xiaoyu YUE, Shenzhen (CN); Zhanghui KUANG, Shenzhen (CN); Hongbin SUN, Shenzhen (CN); Xiaomeng SONG, Shenzhen (CN); Wei ZHANG, Shenzhen (CN)

(21) Appl. No.: 17/232,278

(22) Filed: Apr. 16, 2021

Related U.S. Application Data
(63) Continuation of application No. PCT/CN2019/111170, filed on Oct. 15, 2019.

(30) Foreign Application Priority Data
Sep. 27, 2019 (CN) 201910927338.4

(51) Int. Cl. G06K 9/34; G06K 9/62; G06F 40/284

(52) U.S. Cl. CPC G06K 9/344; G06K 9/6228; G06K 9/6232; G06K 2209/01; G06K 9/6261; G06K 9/6268; G06F 40/284; G06K 9/6257

(57) ABSTRACT

A method and apparatus for recognizing a text sequence, and a storage medium are provided. The method includes: an image to be processed containing a text sequence is acquired; and the text sequence in the image to be processed is recognized according to a recognition network to obtain multiple single characters constituting the text sequence, and character parallel processing is performed on the multiple single characters to obtain a recognition result.

### CROSS-REFERENCE TO RELATED APPLICATION

The present disclosure is a continuation application of International Application No. PCT/CN2019/111170, filed on Oct. 15, 2019, which claims priority to Chinese Patent Application No. 201910927338.4, filed on Sep. 27, 2019 and entitled “Method and Apparatus for Recognizing Text Sequence, Electronic Device and Storage Medium”. The disclosures of International Application No. PCT/CN2019/111170 and Chinese Patent Application No. 201910927338.4 are hereby incorporated by reference in their entireties.

### BACKGROUND

In the recognition scenario of text sequence, the recognition of irregular text plays an important role in fields such as visual understanding and autonomous driving. A large amount of the irregular texts exists in natural scenes such as traffic signs and storefront signs. Due to factors such as changes in the viewing angle and the lighting, the difficulty of recognizing the irregular text is higher than that of regular text, and thus the performance of recognizing the irregular text needs to be improved.

### SUMMARY

The present disclosure relates generally to the field of data processing technologies, and particularly to a method and an apparatus for recognizing a text sequence, an electronic device and a storage medium.

According to a first aspect of the present disclosure, there is provided a method for recognizing a text sequence, the method includes the following operations.

An image to be processed containing a text sequence is acquired.

The text sequence in the image to be processed is recognized according to a recognition network to obtain multiple single characters constituting the text sequence, and character parallel processing is performed on the multiple single characters to obtain a recognition result.

According to a second aspect of the present disclosure, there is provided an apparatus for recognizing a text sequence, the apparatus includes an acquiring unit and a recognizing unit.

The acquiring unit is configured to acquire an image to be processed containing a text sequence.

The recognizing unit is configured to recognize the text sequence in the image to be processed according to a recognition network to obtain multiple single characters constituting the text sequence, and perform character parallel processing on the multiple single characters to obtain a recognition result.

According to a third aspect of the present disclosure, there is provided an electronic device including: a processor, and a memory configured to store instructions that, when executed by the processor, cause the processor to perform the following operations.

An image to be processed containing a text sequence is acquired.

The text sequence in the image to be processed is recognized according to a recognition network to obtain multiple single characters constituting the text sequence, and character parallel processing is performed on the multiple single characters to obtain a recognition result.

According to a fourth aspect of the present disclosure, there is provided a non-transitory computer-readable storage medium having stored thereon computer program instructions that, when executed by a computer, cause the computer to perform the following operations.

An image to be processed containing a text sequence is acquired.

The text sequence in the image to be processed is recognized according to a recognition network to obtain multiple single characters constituting the text sequence, and character parallel processing is performed on the multiple single characters to obtain a recognition result.

It should be understood that the above general description and the following detailed description are only exemplary and explanatory, rather than limiting the present disclosure.

According to the following detailed description of exemplary embodiments with reference to the accompanying drawings, other features and aspects of the present disclosure will become clear.

### BRIEF DESCRIPTION OF THE DRAWINGS

The drawings herein are incorporated into the specification and constitute a part of the specification. These drawings illustrate embodiments that conform to the present disclosure, and are used together with the specification to explain the technical solutions of the present disclosure.

FIG. 1 is a flowchart of a method for recognizing a text sequence according to an embodiment of the present disclosure.

FIG. 2 is a flowchart of a method for recognizing a text sequence according to an embodiment of the present disclosure.

FIG. 3 is a diagram of a convolutional neural network based on an attention mechanism according to an embodiment of the present disclosure.

FIG. 4A to FIG. 4D are diagrams of binary trees included in a convolutional neural network based on an attention mechanism according to an embodiment of the present disclosure.

FIG. 5 is a diagram of a sequence partition-aware attention module in a convolutional neural network based on an attention mechanism according to an embodiment of the present disclosure.

FIG. 6 is a block diagram of an apparatus for recognizing a text sequence according to an embodiment of the present disclosure.

FIG. 7 is a block diagram of an electronic device according to an embodiment of the present disclosure.

FIG. 8 is a block diagram of an electronic device according to an embodiment of the present disclosure.

### DETAILED DESCRIPTION

Various exemplary embodiments, features, and aspects of the present disclosure will be described in detail below with reference to the drawings. The same reference numerals in the drawings indicate elements with the same or similar functions. Although various aspects of the embodiments are illustrated in the drawings, unless otherwise noted, the drawings are not necessarily drawn to scale.

The dedicated word “exemplary” herein means “serving as an example, embodiment, or illustration”. Any embodiment described herein as “exemplary” need not to be construed as being superior or better than other embodiments.

The term “and/or” herein is only an association relationship describing associated objects, which means that there can be three relationships. For example “A and/or B” can have three meanings: A exists alone, A and B exist at the same time and B exists alone. In addition, the term “at least one” herein means any one of the multiple or any combination of at least two of the multiple. For example, including at least one of A, B or C, can mean including any one or more elements selected from a set formed by A, B and C.

In addition, in order to better illustrate the present disclosure, numerous specific details are given in the following specific embodiments. Those skilled in the art should understand that without certain specific details, the present disclosure can also be implemented. In some instances, the methods, means, elements, and circuits well-known to those skilled in the art have not been described in detail in order to highlight the gist of the present disclosure.

In the recognition scenario of text sequence, the regular text can be recognized, and the irregular text can also be recognized. Taking the recognition of irregular text as an example, for example, a store name or logo of a store is the irregular text, and traffic signs are the irregular text, the recognition of the irregular text plays an important role in fields such as visual understanding and autonomous driving.

Although for the recognition of the regular text, tasks such as document parsing have been better solved in related technologies. However, different from the recognition of the regular text, for the recognition of the irregular text, because a large amount of the irregular texts exists in natural scenes such as traffic signs and storefront signs, and it is far more difficult to recognize due to factors such as changes in the viewing angle and lighting, the recognition technology of the regular text cannot meet the application requirements of recognition of the irregular text.

In the recognition technology of the irregular text, an encoding-decoding framework can be used, herein, an encoder part and an decoder part can be implemented by using a recursive neural network. The recursive neural network is a serial processing network, the essence of which is to provide one input at each step and get an output result accordingly. Regardless of whether it is for the regular text or the irregular text, the encoding and decoding using the recursive neural network have to perform encoding and decoding output character by character.

When the recursive neural network is applied to the recognition of the regular text, a convolutional neural network can be used to down-sample an input image to finally get a feature map with a height of 1 pixel and a width of w pixels, and then the recursive neural network such as a long short-term memory (LSTM) can be used to encode the characters in the text sequence from left to right to obtain a feature vector, and then a connectionist temporal classification (CTC) algorithm is used to perform decoding operations, so as to obtain a final output of the characters.

When the recursive neural network is applied to the recognition of the irregular text, the characters in the text sequence can be encoded from left to right. In order to better extract the image features, the attention module and the recursive neural network can be used in combination to extract the image features, the network can be a convolutional neural network structure. The way of using the convolutional neural network structure is basically the same as the above-mentioned method for the recognition of the regular text, but the down-sampling magnification is controlled, so that the height of the final feature map is h rather than 1. After that, a max pooling layer is used to make the height of the feature map become 1, and then the recursive neural network is still used for encoding, and the last output of the recursive neural network is taken as the encoding result. The decoder is replaced with another recursive neural network, the first recursive input is the output of the encoder, and then each recursive output will be input to the attention module to weight the feature map, so as to obtain the text output of each step. The text output of each step corresponds to a character, and the last output is an end character.

In summary, whether it is the recognition of the regular text or the recognition of the irregular text, the recursive neural network is used as the encoder or the decoder. The text recognition is essentially a serialized task. If the recursive neural network is used for encoding or decoding, due to that the recursive neural network can only perform serial processing, the output of each recursion often depends on the previous output, which is easy to cause cumulative errors, resulting in low accuracy of the text recognition, and the serial processing also limits the processing efficiency of the text recognition to a large extent. It can be seen that the serial processing characteristic of the recursive neural network is not applicable to the serialized text recognition task. In particular, the recognition of the irregular text largely relies on encoding of contextual semantics by the decoder, rather than encoding of the image feature, which will result in lower recognition accuracy for some scenes relating to repeated characters or text without semantics, such as license plate number recognition.

The recognition network (which can be a convolutional neural network based on an attention mechanism) of the present disclosure is used to recognize a text sequence in an image to be processed to obtain multiple single characters constituting the text sequence, and character parallel processing can be performed on the multiple single characters according to the recognition network to obtain a recognition result containing for example, the text sequence composed of the multiple single characters. Thus, through the recognition network and the parallel processing, the recognition accuracy and recognition efficiency of the text sequence recognition task are improved. Herein, the process of recognition through the recognition network can include: encoding is performed based on a binary tree to obtain binary tree node features of text segments in the text sequence; and in a case of performing decoding based on the binary tree, single character recognition is performed according to the binary tree node features. The encoding and the decoding based on the binary tree are also a parallel processing mechanism, which further improves the recognition accuracy and the recognition efficiency of the text sequence recognition task.

It should be pointed out that in the present disclosure, the parallel processing based on the binary tree can decompose a serial processing task and allocate it to one or more binary trees for simultaneous processing. The binary tree is a tree-connected data structure. The present disclosure is not limited to the encoding and the decoding based on the binary tree, but can also be encoding and the decoding based on tree-shaped network structures (such as the ternary tree), and/or based on other non-tree-shaped network structures. The network structures that can implement parallel encoding and decoding are all within the protection scope of the present disclosure.

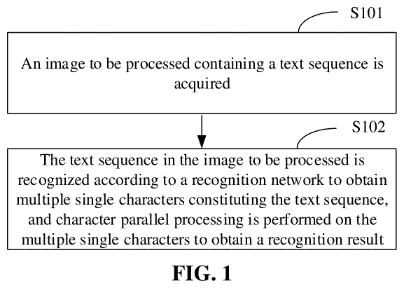

FIG. 1 is a flowchart of a method for recognizing a text sequence according to an embodiment of the present disclosure. The method is applied to an apparatus for recognizing a text sequence. For example, in a case that the apparatus is deployed on a terminal device or a server or other processing device, the apparatus can perform image classification, image detection and video processing and the like. The terminal device can be user equipment (UE), a mobile device, a cellular phone, a cordless phone, a personal digital assistant (PDA), a handheld device, a computing device, a vehicle-mounted device, a wearable device or the like. In some possible implementations, the method can be implemented by a processor through invoking computer readable instructions stored in a memory. As illustrated in FIG. 1, the process of the method includes the following operations.

In S101, an image to be processed containing a text sequence is acquired.

In an example, the image to be processed containing the text sequence (such as an irregular text sequence) can be obtained by performing image acquisition on a target object (such as the name of a certain store). Of course, the image to be processed can also be received from an external device. The irregular text sequence can be the name or logo of the store, or various traffic signs or the like. Whether the text sequence is regular can be judged by the shape of the text line. For example, a single horizontal text line means that the text sequence is regular, whereas a curved text line (such as the logo of Starbucks) means that the text sequence is irregular.

In S102, the text sequence in the image to be processed is recognized according to a recognition network to obtain multiple single characters constituting the text sequence, and character parallel processing is performed on the multiple single characters to obtain a recognition result.

In an example, the multiple single characters in the text sequence in the image to be processed can be recognized according to a binary tree configured in the recognition network. The recognition network can be a convolutional neural network based on an attention mechanism. The present disclosure does not limit the specific network structure of the recognition network. Any neural network that can be configured with a binary tree and can recognize multiple single characters based on the binary tree is within the protection scope of the present disclosure.

In an example, character parallel processing is performed on the multiple single characters according to the recognition network to obtain the text sequence composed of the multiple single characters. The text sequence is the recognition result. Use of a binary tree configured in the recognition network of the present disclosure to perform the following encoding and decoding, the text sequence can be cut into text segments to recognize the multiple single characters in the text segments. After recognizing the multiple single characters, the recognition network is further used to perform character parallel processing. Since the essence of the recognition network is a neural network model based on an artificial neural network, and one characteristic of the neural network model is that it can realize parallel distributed processing, the multiple single characters can be processed separately in parallel based on the neural network model, thereby obtaining the text sequence composed of the multiple single characters.

The recognition process can include: 1) performing encoding based on the binary tree to obtain binary tree node features of text segments in the text sequence; and 2) in a case of performing decoding based on the binary tree, performing single character recognition based on the binary tree node features. For example, a feature map can be obtained through a feature extraction module, and then the feature map is input into an attention mechanism-based sequence partition-aware attention module for encoding, to generate features of corresponding nodes of a binary segmentation tree, that is, the binary tree node features of the text segments as mentioned above. Then, the binary tree node features of the text segments are output to a classification module for decoding. The classification can be performed twice in the decoding processing to recognize the meaning of single characters in the text segments.

In related technologies, a recursive neural network is used to perform serial processing. For example, for irregular text, characters are encoded from left to right, and the encoding depends on the semantic relationship between the characters. However, According to the present disclosure, after acquiring an image to be processed containing a text sequence, multiple single characters constituting the text sequence can be obtained by a recognition network (such as a convolutional neural network based on an attention mechanism), and character parallel processing is performed on the multiple single characters to obtain a recognition result. Because there is no need to depend on the semantic relationship between characters, and the recognition result can be obtained by directly performing parallel processing on the multiple single characters obtained, thereby improving the recognition accuracy and processing efficiency of the text recognition task.

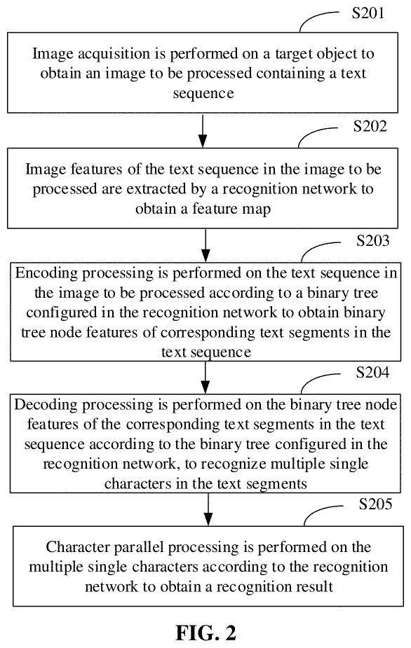

FIG. 2 is a flowchart of a method for recognizing a text sequence according to an embodiment of the present disclosure. As illustrated in FIG. 2, the process of the method includes the following operations.

In S201, image acquisition is performed on a target object to obtain an image to be processed containing a text sequence.

The image acquisition can be performed on a target image by an acquisition apparatus including an acquisition processor (such as a camera), to obtain the image to be processed containing the text sequence, such as an irregular text sequence.

In S202, image features of the text sequence in the image to be processed are extracted by a recognition network to obtain a feature map.

In an example, the image features of the text sequence in the image to be processed are extracted by the recognition network (such as a convolutional neural network based on an attention mechanism) to obtain an image convolution feature map. In related technologies, recursive neural networks can only be used for performing serial processing. For example, for irregular text, characters are encoded from left to right. In this way, image features cannot be extracted well, and what is extracted usually is the contextual semantics. However, what is extracted by the recognition network of the present disclosure the image convolution feature map which contains more feature information than the contextual semantics, thereby being helpful for subsequent recognition processing.

In an example, the attention mechanism for the convolutional neural network based on the attention mechanism can be a sequence partition-aware attention rule.

Herein, the attention mechanism is widely used in at least one of different types of deep learning tasks such as natural language processing, image recognition, and speech recognition. The purpose of the attention mechanism is to select, from a large amount of information, information that is more critical to the current task goal, which improves the accuracy and processing efficiency of screening out high-value information from the large amount of information. Generally speaking, the attention mechanism mentioned above is similar to the attention mechanism of humans. For example, humans obtain, by quickly scanning the text, the area (i.e., the focus of the attention) that needs to be focused on, and then invest more attention resources in this area to obtain more detailed information of the target that requires more attention, so as to suppress other useless information, thereby achieving the purpose of screening out high-value information.

Herein, the sequence partition-aware attention rule is used to characterize a position of a single character in the text sequence. Because this rule can characterize the position of the single character in the text sequence, and the purpose of encoding based on the binary tree is to split the text sequence into text segments and then recognize multiple single characters in the text segments, without depending on the semantics between characters; and because in order to correspond to the encoding of the binary tree and subsequent decoding, each of the text segments is described by a binary tree node feature of the text segment in the text sequence through the encoding, this rule is followed and a breadth-first traversal of the binary tree is performed according to this rule, so that parallel encoding is realized in the case that the encoding does not depend on the semantics between characters, which improves the recognition accuracy and processing efficiency. In other words, when a text sequence or a speech signal sequence is input to the recognition network of the present disclosure, the sequence partition-aware attention rule and the binary tree can be used to convert the sequence into a description of the middle layer (for example, the description of binary tree node features of the text segments), and then obtain a final recognition result based on information provided by the description of the middle layer.

Considering ‘breadth-first traversal’, the breadth-first traversal refers to searching and traversing along the breadth of the binary tree from a root node, and traversing at least one node of the tree in depth, so as to search for at least one branch of the binary tree. For example, starting from a node of the binary tree (which can be a root node or a leaf node), other nodes connected to this node are checked to obtain the at least one visit branch.

From the perspective of a network structure, the convolutional neural network based on the attention mechanism includes at least: a feature extraction module (which can be implemented by a graph convolutional neural network) configured to extract a feature map, and a sequence partition-aware attention module that is based on a sequence partition-aware attention rule and is implemented in combination with a binary tree. The text sequence in the image to be processed can be input into the feature extraction module for feature extraction to obtain the feature map, herein, the feature extraction module is a backbone module of a front end of the recognition network. The feature map can be input to the sequence partition-aware attention module containing the binary tree, and the sequence partition-aware attention module is used to encode the input feature map to generate a respective feature corresponding to each node of the binary segmentation tree, that is, binary tree node features of the text segments in the text sequence, herein, the sequence partition-aware attention module is a character position discrimination module of the convolutional neural network based on the sequence partition-aware attention rule. The sequence partition-aware attention module can also be connected to a classification module, so as to input the binary tree node features of the text segments in the text sequence into the classification module for decoding processing.

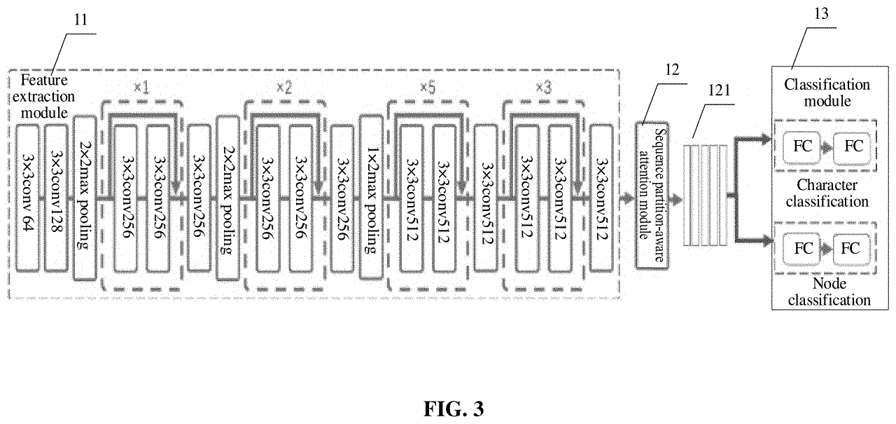

FIG. 3 is a diagram of a convolutional neural network based on an attention mechanism according to an embodiment of the present disclosure, including: a feature extraction module 11, a sequence partition-aware attention module 12 and a classification module 13. The sequence partition-aware attention module 12 contains a preset binary tree (also called a binary segmentation tree or a binary selection tree). The feature extraction module 11 can generate a corresponding feature map (such as image convolution feature map) according to an input image. The sequence partition-aware attention module 12 can use the feature map output by the feature extraction module as input and perform encoding according to the binary tree contained in the sequence partition-aware attention module, and perform feature extraction on text segments at different positions of the text sequence to generate a respective feature corresponding to each binary tree node, such as binary tree node features of the corresponding text segments in the text sequence. The classification module 13 can classify the output result 121 of the sequence partition-aware attention module to obtain the final recognition result. That is to say, after the classification processing, the text sequence composed of the text segments is recognized and used as the recognition result. Herein, the feature extraction module can be a convolutional neural network (CNN) or a graph convolutional network (GCN). The sequence partition-aware attention module can be a sequence partition-aware attention network (SPA2Net).

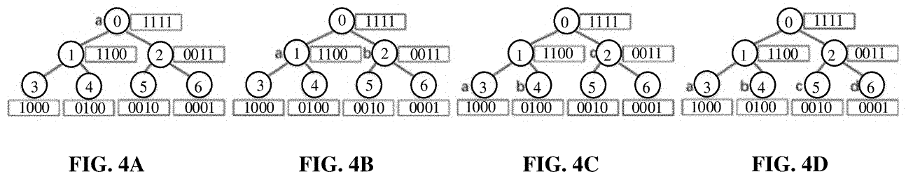

Herein, in the process of performing encoding based on the binary tree configured in the sequence partition-aware attention module, since each node of the binary tree is a vector with the same dimension as the number of channels of the image convolution feature map, when performing selection of each channel of the image convolution feature map through the binary tree, the attention position of the character sequence part being focused on currently can be obtained from the selected channel group. Herein, the node channel value of the binary tree corresponding to the selected channel is 1, and the others are 0. For example, “a string of consecutive numbers 1” can be used to represent a group of channels. Each node of the binary tree is a vector, and the number 1 and 0 can be used to represent the binary tree node feature. As illustrated in FIG. 4A to FIG. 4D, the attention position of character sequence part being focused on currently is described by the encoding based on node features. It is also possible to perform the processing of selection of each channel after an attention matrix is obtained according to the image convolution feature map. After performing the processing of selection of each channel, the different attention feature maps obtained therefrom and the image convolution feature map are weighted to obtain a weighted sum, and twice classification based on a full connected layer (FC layer) of the neural network (such as the FC layer in FIG. 3) can be performed according to the weighted sum obtained. Herein, according to the first classification, it can be judged whether there is only one character contained in the character sequence position. If there is more than one character contained in the character sequence position, the next binary tree-based text segmentation encoding processing of the text segment is performed. If there is only one character contained in the character sequence position, the second classification is performed, and the category of this single character is classified according to the second classification to learn the semantic feature of the single character, so as to recognize the meaning of the single character according to the semantic feature.

Since each node of the binary tree configured in the sequence partition-aware attention module can be calculated in parallel, and the prediction of each character does not depend on the prediction of the characters before and after the character, after multiple single characters are obtained through the encoding performed by leaf nodes of the binary tree, at least one character output can be obtained by performing the breadth-first traversal of the binary tree according to (or following) the above sequence partition-aware attention rule on which the sequence partition-aware attention module is based. Thus, parallel encoding can be realized in the case that the encoding does not depend on the semantics between the characters, which improves the recognition accuracy and processing efficiency. FIG. 4A to FIG. 4D are diagrams of binary trees included in a convolutional neural network based on an attention mechanism according to an embodiment of the present disclosure. The encoding formats used in FIG. 4A to FIG. 4D are used to respectively encode character strings with different lengths according to different binary trees. A text segment can be encoded via a binary tree illustrated in FIG. 4A, herein, the text segment contains a single character “a”. A text segment can be encoded via a binary tree illustrated in FIG. 4B, herein, the text segment is “ab” which contains multiple single characters “a” and “b”. A text segment can be encoded via a binary tree illustrated in FIG. 4C, herein, the text segment is “abc” which contains multiple single characters “a”, “b” and “c”. A text segment can be encoded via a binary tree illustrated in FIG. 4D, herein, the text segment is “abcd” which contains multiple single characters “a”, “b”, “c” and “d”. In at least one binary tree, each node is calculated in parallel. In specific applications, a breadth-first traversal can be added as above to obtain at least one access branch.

In S203, encoding processing is performed on the text sequence in the image to be processed according to a binary tree configured in the recognition network to obtain binary tree node features of corresponding text segments in the text sequence.

In an example, encoding processing used for text segmentation of the text sequence (which can be referred to as the encoding processing of the text segmentation) is performed on the text sequence in the image to be processed according to the binary tree configured in the recognition network.

In S204, decoding processing is performed on the binary tree node features of the corresponding text segments in the text sequence according to the binary tree configured in the recognition network, to recognize multiple single characters in the text segments.

In an example, the process of decoding the binary tree node features according to the binary tree can be implemented by a classification module. The present disclosure is not limited to the implementation of the decoding processing and the specific module structure through classification processing. The decoding processing modules capable of performing decoding based on the binary tree are all within the protection scope of the present disclosure.

For example, the first classification of the classification module is used to determine whether the corresponding text segment in the text sequence contains only one single character. If only one single character is contained, the second classification is performed. If more than one single character is contained, the next encoding processing of the text segmentation is performed. For the second classification, a semantic feature of this single character is recognized. Finally, the multiple single characters in the text segments are recognized.

Through the above operations S203 to S204, the text sequence in the image to be processed can be recognized according to the recognition network to obtain the multiple single characters constituting the text sequence.

In S205, character parallel processing is performed on the multiple single characters according to the recognition network to obtain a recognition result.

In an example, character parallel processing is performed on the multiple single characters according to the recognition network (such as the convolutional neural network based on the attention mechanism) to obtain the text sequence composed of the multiple single characters. The text sequence is the recognition result.

According to the present disclosure, the encoding processing and the corresponding decoding processing can be performed on the text sequence in the image to be processed according to the binary tree configured in the recognition network, and the recognition network can perform parallel processing based on the sequence partition-aware attention rule. That is to say, in the present disclosure, the encoding and the decoding processing performed based on the recognition network including the binary tree are also parallel, and through the binary tree in the recognition network, a fixed proportion of channels can be used to encode text line positions of the same proportion of length.

Herein, the implementation principle of dichotomy on which the binary tree is based is as follows. For a text sequence, a number in the middle of the text sequence is taken in a manner of “fixed proportion of ½” each time to perform comparison to determine how the text sequence is partitioned into two text segments, and comparison is further performed for the text segment obtained through partition in manner of “fixed proportion of ½” to obtain a comparison result, and partition processing will not be ended until there is only one single character left. In the case that the dichotomy is applied to the binary tree, since the structure of the binary tree includes a root node, leaf nodes under the root node, and child nodes of the leaf nodes under the leaf nodes and the like, and a channel connecting at least one node is called a node channel, the encoding of the binary tree can be understood as follows. The text sequence is partitioned in a manner of “½ fixed proportion channel” each time and it is determined how to remove the half of text segments each time to enable the text segment left after removing the half of the text segments to serve as the node feature of the next node corresponding to the text segment, and comparison is further performed for the text segment obtained through partition in a manner of “½ fixed proportion channel” to obtain a comparison result, and the partition processing will not be ended until there is only one single character left. For example, the root node of the binary tree is used to represent the entire text sequence “abcdf”, and the root node is used for encoding 5 characters. The left child and right child after the root node (the left child and right child refer to the leaf nodes of the root node, and there can also be child nodes of the leaf node under the leaf node, etc.) respectively correspond to the former-half text segment “abc” and the latter-half text segment “df” of the text sequence “abcdf” represented by the root node. Then, the former-half text segment “abc” is further partitioned in a manner of “½ fixed proportion channel” to obtain the former-half text segment “ab” and the latter-half text segment “c”. For the node channel containing the latter-half text segment “c”, since there is only a single character left, the partition of this node channel is ended. The former-half text segment “ab” is further partitioned in a manner of “½ fixed proportion channel” to obtain the former-half text segment “a” and the latter-half text segment “b”. Since there is only a single character left, the partition of this node channel is ended. In the same way, the text segment “df” is partitioned in a manner of “½ fixed proportion channel” to obtain the former-half text segment “d” and the latter-half text segment “f”. Since there is only a single character left, the partition of this node channel is ended. Although the binary tree is based on the dichotomy and the encoding processing of the partition is based on the “½ fixed proportion channel”, the characters are encoded by using the same proportion length regardless of specific text line position of the characters in the text sequence. For example, a 4-bit length code “1000” can be used to represent “a”, a 4-bit length code “0011” can be used to represent “c”, a 4-bit length code “1100” can be used to represent “ab”, and a 4-bit length code “1111” can be used to represent “abc” and so on. That is to say, the lengths of the codes are the same proportional length, but through different code combinations of “1” and “0”, characters located at different text line positions in the text sequence can be described.

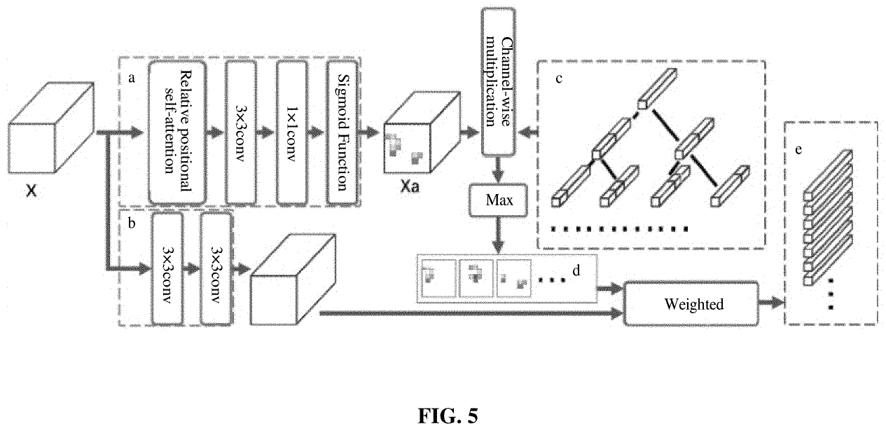

FIG. 5 is a diagram of a sequence partition-aware attention module in a convolutional neural network based on an attention mechanism according to an embodiment of the present disclosure. Through the feature extraction module (such as CNN or GCN), the corresponding feature map (such as the image convolution feature map) can be generated according to the input image. X illustrated in FIG. 5 is the feature map. The sequence partition-aware attention module (such as SPA2Net) takes the feature map output by the feature extraction module as the input, performs encoding according to the binary tree contained in the sequence partition-aware attention module, and performs feature extraction on text segments at different positions in the text sequence to generate a feature corresponding to each binary tree node, such as the binary tree node features of the corresponding text segments in the text sequence. Specifically, a binary tree can be obtained according to a text segment, or, a binary tree can be obtained according to a text sequence, and a node of the binary tree is a text segment.

Herein, an ‘a module’ and a ‘b module’ in the sequence partition-aware attention module can be convolutional neural networks, for example, CNN including two convolutional layers, which can be used to predict attention and change the feature map, respectively. For example, the ‘a module’ is used to obtain the output of the attention after obtaining the feature map X. For example, the output feature can be obtained through the Transformer algorithm operation according to the relative positional self-attention module in FIG. 5, and the operation of at least one convolution module and the nonlinear operation of an Activation function such as Sigmoid function can be performed on the output feature to obtain an attention matrix xₐ. The ‘b module’ is used to continue to extract features to update the feature map. xₐ is the attention matrix output by the ‘a module’, and a multi-channel selection is performed on xₐ by a ‘c module’ (such as a module containing a binary tree). For example, in FIG. 5, the ‘c module’ is used to perform channel-wise multiplication operation on xₐ to obtain an attention feature map d of each channel. The weighted sum operation is performed on the output of the ‘b module’ by using the selected different attention feature maps d, to extract the feature e of each part, and the feature e is used as the output result 121 obtained by the sequence partition-aware attention module and is provided to the classification module for classification processing. Here, the feature e is used to characterize the feature of a certain text segment in the entire text sequence, which can be called the feature corresponding to each binary tree node, such as the binary tree node features of the corresponding text segments in the text sequence. In the process of the classification processing through the classification module, the feature will first be classified whether it is a feature recognized from a single character, if it is the feature recognized from the single character, the category of this single character will be classified directly to learn about its semantic feature, and then the meaning of this single character is recognized according to the semantic feature.

The processing of the above sequence partition-aware attention module is mainly implemented by the following formula (1) to formula (3). Herein, the formula (1) is used to calculate the attention matrix xₐ output by the ‘a module’, the formula (2) is used to calculate the selected different attention feature maps d after the multi-channel selection is performed on the attention matrix xₐ by the ‘c module’ (such as a module containing a binary tree), and the formula (3) is used to calculate the feature e, where different attention feature maps d are used to perform the weighted sum on the output of the ‘b module’ to extract the feature e of each part, and the feature e is taken as the output result 121 obtained by the sequence partition-aware attention module.

$$\begin{matrix}{X}_{a} = δ ( T ( X ) * {w}_{a 1} * {w}_{a 2} ) & ( 1 ) \\ d = \frac{maxpool ( {( {X}_{a} )}_{i ⊙} {p}_{t} )}{{\sum }_{i} maxpool ( {( {X}_{a} )}_{i ⊙} {p}_{t} )} & ( 2 ) \\ e = {\sum }_{i}^{H \times W} {d ( X * {W}_{f 1} * {W}_{f 2} )}_{i} & ( 3 )\end{matrix}$$

Herein, in formula (1), X represents the convolution feature map of the input image obtained by the feature extraction module; wₐ₁ and wₐ₂ represent convolution kernels of the convolution operation, respectively; * represents a convolution operator; T(X) represents the output feature obtained through performing the operation on the feature map X by the relative positional self-attention module; and S represents an operation of the activation function such as the Sigmoid function, and finally the attention matrix xₐ output by the ‘a module’ is obtained. In formula (2), xₐ represents the attention matrix output by the ‘a module’; 0 represents a channel-wise multiplication operator; pₜ represents the t-th binary tree node feature (i.e., encoding of a character position of a corresponding text segment) in an encoding processing of partitioning the text sequence into corresponding text segments based on a binary tree, where t is a serial number of a node of the binary tree, such as the serial number of the node 0 to the serial number of the node 6 as illustrated in FIG. 4A to FIG. 4D; maxpool represents a max pooling operator along the channel direction; and d represents the selected different attention feature maps after the multi-channel selection. In formula (3), X represents the feature map of the input image obtained by the feature extraction module; W_{f1} and W_{f2} represent convolution kernels of the convolution operation, respectively; H and W represent the height information and width information of the attention feature map d, respectively; d represents the selected different attention feature maps after the multi-channel selection; e represents feature vectors obtained by weighting different attention feature maps d and the convolution feature map (the output of the ‘b module’). The i in the formula (2) and formula (3) represents a traversal parameter used for the breadth-first traversal based on the binary tree. It should be pointed out that both d and e are general expressions, d can be dl, and dl specifically refers to a certain feature map corresponding to a position of a binary tree node i that is traversed; e can be el, and el specifically refers to a feature vector obtained according to dl.

The encoding part of the present disclosure is described as follows.

In a possible implementation, the encoding processing of text segmentation is performed on the text sequence in the image to be processed according to the binary tree to obtain binary tree node features of corresponding text segments in the text sequence, which includes: inputting the feature map to a sequence partition-aware attention module containing the binary tree, herein, the sequence partition-aware attention module is a character position discrimination module of the recognition network; performing multiple-channel (for example, each channel) selection on the feature map according to the binary tree to obtain multiple target channel groups; and performing the encoding of text segmentation according to the multiple target channel groups to obtain the binary tree node features of the corresponding text segments in the text sequence.

In a possible implementation, performing multiple-channel selection on the feature map according to the binary tree includes: processing the feature map based on the sequence partition-aware attention rule to obtain an attention feature matrix (such as xₐ illustrated in FIG. 5), and performing multi-channel selection on the attention feature matrix according to the binary tree. For example, the attention feature matrix is obtained by performing prediction through the sequence partition-aware attention rule, and then the attention feature matrix is provided to the binary tree for performing the multi-channel selection, and finally multiple different attention feature maps (such as d illustrated in FIG. 5) are output.

In a possible implementation, performing text segmentation according to the multiple target channel groups to obtain the binary tree node features of the corresponding text segments in the text sequence includes: performing the encoding of text segmentation on the multiple target channel groups obtained by performing the multi-channel selection on the feature map according to the binary tree to obtain multiple attention feature maps (such as d in FIG. 5); performing convolution processing on the feature map that are initially input to the recognition network to obtain a convolution processing result (such as the output of the ‘b module’ illustrated in FIG. 5); and weighting the multiple attention feature maps and the convolution processing result to obtain a weighted result, and obtaining the binary tree node features (such as e in FIG. 5) of the corresponding text segments in the text sequence according to the weighted result.

The decoding part of the present disclosure is relatively simpler compared with the encoding part. Two classifiers (such as a node classifier and a character classifier) can be included in a classification module to perform classification twice. The node classifier is used to perform the first classification in which the binary tree node features are classified to obtain the output of the node classifier, and an output result (a single character) is input into the character classifier for the second classification in which text semantics corresponding to the single character is classified.

The decoding part of the present disclosure is described as follows.

In a possible implementation, performing decoding processing on the binary tree node features according to the binary tree to recognize the multiple single characters in the text segments includes: inputting the binary tree and the binary tree node features into the classification module for performing node classification to obtain a classification result; and recognizing the multiple single characters in the text segments according to the classification result. Herein, recognizing the multiple single characters in the text segments according to the classification result includes: in a case that the classification result is a feature corresponding to a single character, it is indicated that the text segment corresponding to the binary tree node feature contains a single character, determining a text semantic corresponding to the single character (to obtain the meaning corresponding to the single character), to recognize a semantic category corresponding to the single character.

Those skilled in the art can understand that in the above-mentioned methods of the specific implementation, the order of the operations recited does not mean a strict execution order which can constitute any limitation to the implementation process. The specific execution order of each operation should be determined based on its function and possible inner logic.

The foregoing various method embodiments mentioned in the present disclosure can all be combined with each other to form a combined embodiment without violating the principle and logic. Due to space limitations, details will not be repeated in the present disclosure.

In addition, the present disclosure also provides an apparatus for recognizing a text sequence, an electronic device, a computer-readable storage medium and programs, all of which can be used to implement any method for recognizing the text sequence recognition in the present disclosure. The corresponding technical solutions and descriptions can be found in the corresponding records in the method part which will not be repeated here.

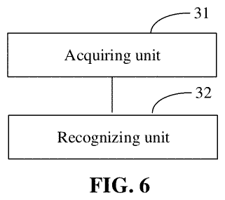

FIG. 6 is a block diagram of an apparatus for recognizing a text sequence according to an embodiment of the present disclosure. As illustrated in FIG. 6, the apparatus includes: an acquiring unit 31 configured to acquire an image to be processed containing a text sequence; and a recognizing unit 32 configured to recognize the text sequence in the image to be processed according to a recognition network to obtain multiple single characters constituting the text sequence, and perform character parallel processing on the multiple single characters to obtain a recognition result.

In such a manner, an image to be processed containing a text sequence is acquired, since multiple single characters constituting the text sequence can be obtained by recognition of the text sequence according to a recognition network without depending on the semantic relationship between the characters, character parallel processing is performed on the multiple single characters to obtain a recognition result, so that the recognition accuracy is improved, and processing efficiency is improved due to the parallel processing.

In a possible implementation, the recognizing unit is configured to recognize the multiple single characters constituting the text sequence in the image to be processed according to a binary tree configured in the recognition network.

In such a manner, the processing based on the binary tree can perform parallel encoding and decoding on the multiple single characters, which greatly improves the recognition accuracy of the single character.

In a possible implementation, the recognizing unit is configured to: perform encoding processing on the text sequence in the image to be processed according to the binary tree to obtain binary tree node features of corresponding text segments in the text sequence; and perform decoding processing on the binary tree node features according to the binary tree to recognize the multiple single characters constituting the text segments.

In such a manner, in the process of encoding based on the binary tree, encoding processing can be performed on the text sequence in the image to be processed to obtain the binary tree node features of the corresponding text segments in the text sequence. That is to say, a text sequence is converted into node features of a binary tree through the encoding, so as to facilitate subsequent decoding processing based on the binary tree.

In a possible implementation, the recognizing unit is configured to: extract image features of the text sequence in the image to be processed through the recognition network to obtain a feature map, so as to recognize the text sequence according to the feature map to obtain the multiple single characters constituting the text sequence.

In such a manner, image features of the text sequence in the image to be processed can be extracted through the recognition network to obtain a feature map. Since the processing is performed based on the image features for facilitating the subsequent semantic analysis, rather than directly extracting the semantic, the result of semantic analysis is more accurate, thereby improving the recognition accuracy.

In a possible implementation, the recognizing unit is configured to: input the text sequence in the image to be processed into a feature extraction module; and obtain the feature map through feature extraction performed by the feature extraction module.

In such a manner, feature extraction can be performed by the feature extraction module in the recognition network. Since the network is capable of adjusting parameters self-adaptively, the feature map obtained through the feature extraction is more accurate, thereby improving the recognition accuracy.

In a possible implementation, the recognizing unit is configured to: input the feature map into a sequence partition-aware attention module based on a sequence partition-aware attention rule; perform a multi-channel selection on the feature map according to the binary tree contained in the sequence partition-aware attention module to obtain multiple target channel groups; and perform text segmentation according to the multiple target channel groups to obtain the binary tree node features of the corresponding text segments in the text sequence.

In such a manner, in the process of encoding based on a binary tree, the encoding can be performed through a sequence partition-aware attention module in the recognition network to obtain the binary tree node features of the corresponding text segments in the text sequence. That is to say, a text sequence is converted into node features of a binary tree through the encoding performed by the binary tree in the sequence partition-aware attention module, so as to facilitate subsequent decoding processing based on the binary tree. Since the network is capable of adjusting parameters self-adaptively, the encoding result obtained through the sequence partition-aware attention module is more accurate, thereby improving the recognition accuracy.

In a possible implementation, the recognizing unit is configured to: perform processing on the feature map based on the sequence partition-aware attention rule to obtain an attention feature matrix, and perform the multiple-channel selection on the attention feature matrix according to the binary tree.

In such a manner, in the process of encoding performed by the binary tree in sequence partition-aware attention module, after the attention feature matrix is obtained, the multi-channel selection is performed on the attention feature matrix according to the binary tree, so as to obtain multiple target channel groups used for text segmentation.

In a possible implementation, the recognizing unit is configured to: perform text segmentation according to the multiple target channel groups to obtain multiple attention feature maps; perform convolution processing on the feature map to obtain a convolution processing result; and weight the multiple attention feature maps and the convolution processing result to obtain a weighted result and obtain the binary tree node features of the corresponding text segments in the text sequence according to the weighted result.

In such a manner, in the process of encoding performed by the binary tree in sequence partition-aware attention module, text segmentation is performed according to the multiple target channel groups to obtain multiple attention feature maps, and the multiple attention feature maps and the convolution processing result obtained by performing convolution processing on the feature map are weighted to obtain a weighted result, and then the binary tree node features of the corresponding text segments in the text sequence can be obtained according to the weighted result, so as to facilitate subsequent decoding processing based on the binary tree.

In a possible implementation, the recognizing unit is configured to: input the binary tree and the binary tree node features into a classification module to perform node classification to obtain a classification result; and according to the classification result, recognize the multiple single characters constituting the text segments.

In such a manner, the decoding process based on the binary tree can use a classification module for performing classification processing. The classification processing can input the binary tree and the binary tree node features obtained through the previously encoding into the classification module in the recognition network to perform node classification to obtain a classification result, and recognize the multiple single characters constituting the text segments according to the classification result. The decoding processing based on the binary tree is also parallel, and the network is capable of adjusting parameters self-adaptively. Therefore, the decoding result obtained through the classification module is more accurate, thereby improving the recognition accuracy.

In a possible implementation, the recognizing unit is configured to: in a case that the classification result is a feature corresponding to a single character, determine text semantics of the feature corresponding to the single character to recognize a semantic category of the feature corresponding to the single character.

In such a manner, the decoding processing based on the binary tree can use a classification module for performing classification processing. In a case that the classification result obtained by the classification processing is a feature corresponding to a single character, a semantic category of the feature corresponding to the single character can be recognized by determining text semantics of the feature corresponding to the single-character. Since the semantic category is obtained through analysis instead of extracting the semantics directly, the recognition accuracy is improved.

In some embodiments, the functions owned by or modules contained in the apparatus provided in the embodiments of the present disclosure can be used to perform the methods described in the above method embodiments. For specific implementation, please refer to the description of the above method embodiments which will not be repeated here for brevity.

The embodiment of the present disclosure also provides a computer-readable storage medium having stored thereon computer program instructions that, when executed by a processor, cause the processor to implement the above method. The computer-readable storage medium can be a volatile computer-readable storage medium or a non-volatile computer-readable storage medium.

The embodiments of the present disclosure also provide a computer program product, which includes computer-readable codes that, when being run on the device, cause the processor in the device to execute instructions of the text sequence recognition provided by any of the above embodiments.

The embodiments of the present disclosure also provide another computer program product configured to store computer-readable instructions that, when executed, cause a computer to perform the operations of the method for recognizing the text sequence provided by any of the above embodiments.

The computer program product can be specifically implemented by hardware, software or a combination thereof. In an optional embodiment, the computer program product is specifically embodied as a computer storage medium. In another optional embodiment, the computer program product is specifically embodied as a software product, such as a software development kit (SDK).

An embodiment of the present disclosure further provides an electronic device, including: a processor; and a memory configured to store instructions executable by the processor; herein the processor is configured to implement the above methods.

The electronic device can be provided as a terminal, a server or other forms of device.

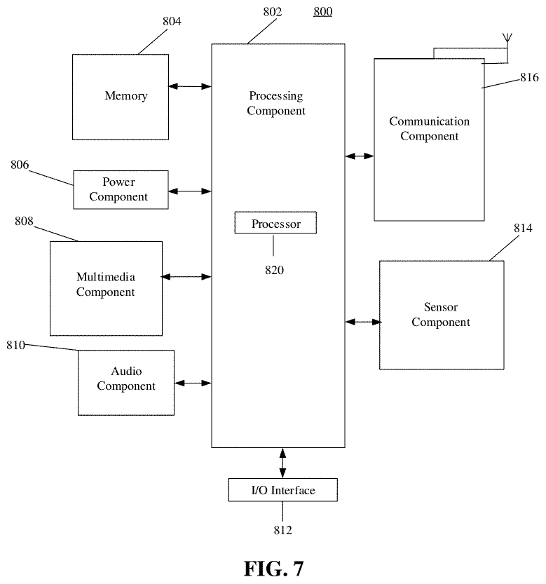

FIG. 7 is a block diagram of an electronic device 800 according to an exemplary embodiment. For example, the electronic device 800 may be a terminal such as a mobile phone, a computer, a digital broadcast terminal, a messaging apparatus, a gaming console, a tablet, a medical apparatus, exercise equipment and a PDA.

Referring to FIG. 7, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the operations in the above method. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 may store various types of data to support the operation on the electronic device 800. Examples of such data include instructions for any application or method operated on the electronic device 800, contact data, phonebook data, messages, pictures, videos, etc. The memory 804 may be implemented by using any type of volatile or non-volatile memory apparatus, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk etc.

The power component 806 may provide power to various components of the electronic device 800. The power component 806 may include a power management system, one or more power sources, and any other components associated with the generation, management, and distribution of power in the electronic device 800.

The multimedia component 808 may include a screen providing an interface (such as the GUI) between the electronic device 800 and the user. In some embodiments, the screen may include a liquid crystal display (LCD) and a touch panel (TP). If the screen includes the touch panel, the screen may be implemented as a touch screen to receive input signals from the user. The touch panel may include one or more sensors to sense touches, swipes, and/or other gestures on the touch panel. The sensors may not only sense a boundary of a touch or swipe action, but also sense a period of time and a pressure associated with the touch or swipe action. In some embodiments, the multimedia component 808 includes a front camera and/or a rear camera. The front camera and/or the rear camera may collect external multimedia data when the electronic device 800 is in an operation mode such as a photographing mode or a video mode. Each of the front camera and the rear camera may be a fixed optical lens system or have focus and optical zoom capability.

The audio component 810 may output and/or input audio signals. For example, the audio component 810 may include a microphone. The microphone may collect an external audio signal when the electronic device 800 is in an operation mode, such as a call mode, a recording mode, and a voice recognition mode. The collected audio signal may be stored in the memory 804 or transmitted via the communication component 816. In some embodiments, the audio component 810 further includes a speaker configured to output audio signals.

The I/O interface 812 may provide an interface between the processing component 802 and peripheral apparatus. The peripheral apparatus may be a keyboard, a click wheel, buttons, and the like. The buttons may include, but are not limited to, a home button, a volume button, a starting button, and a locking button.

The sensor component 814 includes one or more sensors for providing the electronic device 800 with various aspects of state evaluation. For example, the sensor component 814 can detect the on/off state of the electronic device 800 and the relative positioning of the components. For example, the component is the display and the keypad of the electronic device 800. The sensor component 814 can also detect the position change of a component of the electronic device 800 or the electronic device 800, the presence or absence of contact between the user and the electronic device 800, the orientation or acceleration/deceleration of the electronic device 800, and the temperature change of the electronic device 800. The sensor component 814 may include a proximity sensor configured to detect the presence of nearby objects when there is no physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor or a temperature sensor.

The communication component 816 may be configured to facilitate wired or wireless communication between the electronic device 800 and another apparatus. The electronic device 800 may access a communication-standard-based wireless network, such as a Wireless Fidelity (WiFi) network, a 2nd-Generation (2G) or 3rd-Generation (3G) network or a combination thereof. In an exemplary embodiment, the communication component 816 may receive a broadcast signal or broadcast associated information from an external broadcast management system via a broadcast channel. In an exemplary embodiment, the communication component 816 further includes a Near Field Communication (NFC) module to facilitate short-range communications. For example, the NFC module may be implemented based on a Radio Frequency Identification (RFID) technology, an Infrared Data Association (IrDA) technology, an Ultra-Wideband (UWB) technology, a Bluetooth (BT) technology, and other technologies.

In an exemplary embodiment, the electronic device 800 may be implemented as one or more Application Specific Integrated Circuits (ASICs), Digital Signal Processors (DSPs), Digital Signal Processing Apparatus (DSPDs), Programmable Logic Apparatus (PLDs), Field Programmable Gate Arrays (FPGAs), controllers, micro-controllers, microprocessors or other electronic components, to implement the above any method.

In an exemplary embodiment, a computer-readable storage medium may be further provided, such as a memory 804 having stored thereon computer program instructions. The computer program instructions, when being executed by the processor (for example, the processor 820), cause the processor to complete the above method.

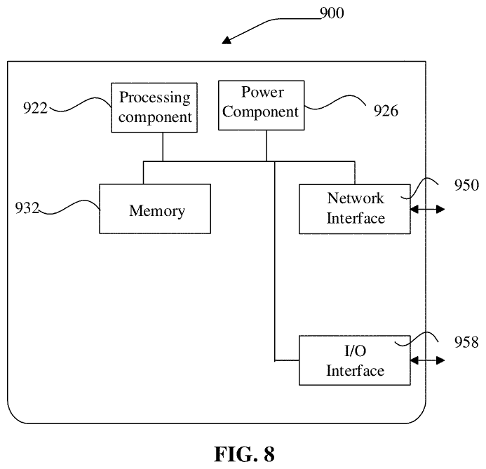

FIG. 8 is a block diagram showing an electronic device 900 according to an exemplary embodiment. For example, the electronic device 900 may be provided as a server. Referring to FIG. 8, the electronic device 900 may include: a processing component 922, including one or more processors; and a memory resource represented by a memory 932, configured to store instructions (for example, application programs) executable by the processing component 922. The processing component 922 may execute the instructions to implement the above method.

The electronic device 900 may further include: a power component 926 configured to execute power management of the electronic device 900; a wired or wireless network interface 950 configured to connect the electronic device 900 to a network; and an I/O interface 958. The electronic device 900 may be operated based on an operating system stored in the memory 932, for example, Windows Server™, Mac OS XTM, Unix™, Linux™, FreeBSD™ or the like.

In an exemplary embodiment, a non-temporary computer-readable storage medium (such as the memory 932 having stored thereon computer program instructions) may further be provided. The computer program instructions are executed by the processing component 922 in the electronic device 900 to implement the above method.

The disclosure may be implemented as a system, a method and/or a computer program product. The computer program product may include a computer-readable storage medium having stored thereon computer-readable program instructions configured to enable a processor to implement the method of the present disclosure.

The computer-readable storage medium may be a tangible apparatus that can hold and store instructions used by the instruction execution apparatus. The computer-readable storage medium may be, for example, but not limited to, an electrical storage apparatus, a magnetic storage apparatus, an optical storage apparatus, an electromagnetic storage apparatus, a semiconductor storage apparatus, or any suitable combination of the foregoing. More specific examples (non-exhaustive list) of computer readable storage medium include: a portable computer disk, a hard disk, a random access memory (RAM), a read only memory (ROM), an erasable programmable read only memory (EPROM or a flash memory), a static random access memory (SRAM), a portable compact disk read-only memory (CD-ROM), a digital versatile disk (DVD), a memory stick, a floppy disk, a mechanical encoding apparatus, such as a punch card or a protruding structure in the groove having stored thereon instructions, and any suitable combination of the above. The computer-readable storage medium used here is not interpreted as a transient signal itself, such as radio waves or other freely propagating electromagnetic waves, electromagnetic waves transmitting through waveguides or other transmission media (for example, light pulses transmitting through fiber optic cables), or electrical signals transmitting through electric wires.

The computer-readable program instructions described herein can be downloaded from a computer-readable storage medium to various computing/processing apparatus, or downloaded to an external computer or external storage apparatus via network, such as the Internet, a local area network, a wide area network, and/or a wireless network. The network may include copper transmission cables, optical fiber transmission, wireless transmission, routers, firewalls, switches, gateway computers, and/or edge servers. The network adapter card or network interface in each computing/processing apparatus receives computer-readable program instructions from the network, and forwards the computer-readable program instructions for storage in the computer-readable storage medium in each computing/processing apparatus.

The computer program instructions used to perform the operations of the present disclosure may be assembly instructions, instruction set architecture (ISA) instructions, machine instructions, machine-related instructions, microcode, firmware instructions, status setting data, or source codes or object codes written by any combination of one or more programming languages, the programming language includes object-oriented programming languages such as Smalltalk, C++, etc., and conventional procedural programming languages such as “C” language or similar programming languages. Computer-readable program instructions can be executed entirely on the computer of the user, partly on the computer of the user, executed as a stand-alone software package, partly on the computer of the user and partly on a remote computer, or entirely on the remote computer or a server. In the case related to the remote computer, the remote computer can be connected to the computer of the user through any kind of network, including a local area network (LAN) or a wide area network (WAN), or the remote computer can be connected to an external computer (for example, using an Internet service provider to provide an Internet connection). In some embodiments, an electronic circuit, such as a programmable logic circuit, a field programmable gate array (FPGA), or a programmable logic array (PLA), can be customized by using the status information of the computer-readable program instructions. The computer-readable program instructions are executed to realize various aspects of the present disclosure.

Herein, various aspects of the present disclosure are described with reference to flowcharts and/or block diagrams of methods, apparatus (systems) and computer program products according to embodiments of the present disclosure. It should be understood that each block of the flowchart and/or block diagram and the combination of each block in the flowchart and/or each block in block diagram can be implemented by computer readable program instructions.

These computer-readable program instructions can be provided to a processor of a general-purpose computer, a special-purpose computer, or other programmable data processing apparatus, thereby producing a machine that makes these instructions, when executed by the processor of the computer or other programmable data processing apparatus, produce an apparatus that implements the functions/actions specified in one or more blocks in the flowchart and/or block diagram. It is also possible to store these computer-readable program instructions in a computer-readable storage medium. These instructions make computers, programmable data processing apparatus, and/or other apparatus work in a specific manner, so that the computer-readable medium storing instructions includes a manufacture, which includes instructions for implementing various aspects of the functions/actions specified in one or more blocks in the flowchart and/or the block diagram.

It is also possible to load computer-readable program instructions on a computer, other programmable data processing apparatus, or other equipment, so that a series of operations are executed on the computer, other programmable data processing apparatus, or other equipment to produce a computer-implemented process, so that the instructions executed on the computer, other programmable data processing apparatus, or other equipment implement the functions/actions specified in one or more blocks in the flowcharts and/or block diagrams.

The flowcharts and block diagrams in the drawings illustrate probably implemented system architectures, functions and operations of the apparatus (system), method and computer program product according to various embodiments of the disclosure. On this aspect, each block in the flowcharts or the block diagrams may represent part of a module, a program segment or an instruction, and the part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed substantially concurrently or may be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation, or may be implemented by a combination of a special hardware and computer instructions.

Without violating logic, different embodiments of the present application can be combined with each other, and the description of different embodiments emphases on different part. For the emphasized part, please refer to the record of other embodiments.

The embodiments of the present disclosure have been described above, the above description is exemplary, not exhaustive, and is not limited to the disclosed embodiments. Without departing from the scope and spirit of the illustrated embodiments, many modifications and changes are obvious to those of ordinary skilled in the art. The choice of terms used herein is intended to best explain the principles, practical applications, or improvements to the technology in the market for each embodiment, or to enable other ordinary skilled in the art to understand the various embodiments disclosed herein.

1. A method for recognizing a text sequence, comprising:
acquiring an image to be processed containing a text sequence; and
recognizing the text sequence in the image to be processed according to a recognition network to obtain a plurality of single characters constituting the text sequence, and performing character parallel processing on the plurality of single characters to obtain a recognition result.

2. The method of claim 1, wherein recognizing the text sequence in the image to be processed according to the recognition network to obtain the plurality of single characters constituting the text sequence comprises:
recognizing the plurality of single characters constituting the text sequence in the image to be processed, according to a binary tree configured in the recognition network.

3. The method of claim 2, wherein recognizing the plurality of single characters constituting the text sequence in the image to be processed according to the binary tree configured in the recognition network comprises:
performing encoding processing on the text sequence in the image to be processed according to the binary tree to obtain binary tree node features of corresponding text segments in the text sequence; and
performing decoding processing on the binary tree node features according to the binary tree to recognize the plurality of single characters constituting the text segments.

4. The method of claim 3, further comprising: after acquiring the image to be processed containing the text sequence,
extracting image features of the text sequence in the image to be processed through the recognition network to obtain a feature map so as to recognize the text sequence according to the feature map to obtain the plurality of single characters constituting the text sequence.

5. The method of claim 4, wherein extracting the image features of the text sequence in the image to be processed through the recognition network to obtain the feature map comprises:
inputting the text sequence in the image to be processed into a feature extraction module; and
obtaining the feature map through feature extraction performed by the feature extraction module.

6. The method of claim 4, wherein performing the encoding processing on the text sequence in the image to be processed according to the binary tree to obtain the binary tree node features of the corresponding text segments in the text sequence comprises:
inputting the feature map into a sequence partition-aware attention module based on a sequence partition-aware attention rule;
performing a multi-channel selection on the feature map according to the binary tree contained in the sequence partition-aware attention module to obtain a plurality of target channel groups; and
performing text segmentation according to the plurality of target channel groups to obtain the binary tree node features of the corresponding text segments in the text sequence.

7. The method of claim 6, wherein performing the multi-channel selection on the feature maps according to the binary tree contained in the sequence partition-aware attention module comprises:
processing the feature map based on the sequence partition-aware attention rule to obtain an attention feature matrix, and performing the multi-channel selection on the attention feature matrix according to the binary tree.

8. The method of claim 6, wherein performing the text segmentation according to the plurality of target channel groups to obtain the binary tree node features of the corresponding text segments in the text sequence comprises:
performing the text segmentation according to the plurality of target channel groups to obtain a plurality of attention feature maps;
performing convolution processing on the feature map to obtain a convolution processing result; and
weighting the plurality of attention feature maps and the convolution processing result to obtain a weighted result, and obtaining the binary tree node features of the corresponding text segments in the text sequence according to the weighted result.

9. The method of claim 4, wherein performing the decoding processing on the binary tree node features according to the binary tree to recognize the plurality of single characters constituting the text segments comprises:
inputting the binary tree and the binary tree node features into a classification module for node classification to obtain a classification result; and
recognizing the plurality of single characters constituting the text segments according to the classification result.

10. The method of claim 9, wherein recognizing the plurality of single characters constituting the text segments according to the classification result comprises:
in a case that the classification result is a feature corresponding to a single character, determining text semantics of the feature corresponding to the single character to recognize a semantic category of the feature corresponding to the single character.

11. An apparatus for recognizing a text sequence, comprising:
a processor; and
a memory configured to store instructions that, when executed by the processor, cause the process to perform the following operations comprising:
acquiring an image to be processed containing a text sequence; and
recognizing the text sequence in the image to be processed according to a recognition network to obtain a plurality of single characters constituting the text sequence, and performing character parallel processing on the plurality of single characters to obtain a recognition result.

12. The apparatus of claim 11, wherein the processor is configured to:
recognize the plurality of single characters constituting the text sequence in the image to be processed according to a binary tree configured in the recognition network.

13. The apparatus of claim 12, wherein the processor is configured to:
perform encoding processing on the text sequence in the image to be processed according to the binary tree to obtain binary tree node features of corresponding text segments in the text sequence; and
perform decoding processing on the binary tree node features according to the binary tree to recognize the plurality of single characters constituting the text segments.

14. The apparatus of claim 13, wherein the processor is configured to:
extract image features of the text sequence in the image to be processed through the recognition network to obtain a feature map, so as to recognize the text sequence according to the feature map to obtain the plurality of single characters constituting the text sequence.

15. The apparatus of claim 14, wherein the processor is configured to:
input the text sequence in the image to be processed into a feature extraction module; and
obtain the feature map through feature extraction performed by the feature extraction module.

16. The apparatus of claim 14, wherein the processor is configured to:
input the feature map into a sequence partition-aware attention module based on a sequence partition-aware attention rule;
perform a multi-channel selection on the feature map according to the binary tree contained in the sequence partition-aware attention module to obtain a plurality of target channel groups; and
perform text segmentation according to the plurality of target channel groups to obtain the binary tree node features of the corresponding text segments in the text sequence.

17. The apparatus of claim 16, wherein the processor is configured to:
perform processing on the feature map based on the sequence partition-aware attention rule to obtain an attention feature matrix, and perform the multi-channel selection on the attention feature matrix according to the binary tree.

18. The apparatus of claim 16, wherein the processor is configured to:
perform the text segmentation according to the plurality of target channel groups to obtain a plurality of attention feature maps;
perform convolution processing on the feature map to obtain a convolution processing result; and
weight the plurality of attention feature maps and the convolution processing result to obtain a weighted result, and obtain the binary tree node features of the corresponding text segments in the text sequence according to the weighted result.

19. The apparatus of claim 14, wherein the processor is configured to:
input the binary tree and the binary tree node features into a classification module for node classification to obtain a classification result; and
recognize the plurality of single characters constituting the text segments according to the classification result.

20. A non-transitory computer-readable storage medium, having stored thereon computer program instructions that, when executed by a computer, cause the computer to perform the following operations comprising:
acquiring an image to be processed containing a text sequence; and
recognizing the text sequence in the image to be processed according to a recognition network to obtain a plurality of single characters constituting the text sequence, and performing character parallel processing on the plurality of single characters to obtain a recognition result.
